(19) United States
(12) Patent Application Publication
(10) Pub. No.: US 2019/0246339 A1
(43) Pub. Date: Aug. 8, 2019

(54) Information Processing Apparatus And Recording Medium

(71) Applicant: FUJITSU CLIENT COMPUTING LIMITED, Kawasaki-Shi (JP)

(72) Inventor: Naozumi ANZAI, Kawasaki-shi (JP)

(21) Appl. No.: 16/384,053

(22) Filed: Apr. 15, 2019

Related U.S. Application Data
(63) Continuation of application No. PCT/JP2017/039237, filed on Oct. 31, 2017.

(30) Foreign Application Priority Data
Dec. 6, 2016 (JP) 2016-236473

(51) Int. Cl. H04W 48/14; H04W 12/08

(52) U.S. Cl. CPC H04W 48/14; H04W 84/12; H04W 12/0808

(57) ABSTRACT

An information processing apparatus includes an acquisition unit configured to acquire information indicating whether a user of a terminal performing communication via an access point is present, and a setting unit configured to set communication addresses of terminals permitted to perform communication via the access point on the basis of information acquired by the acquisition unit.

The present invention relates to an information processing apparatus and a recording medium. This application is a continuation application based on PCT International Application No. PCT/JP2017/039237, filed on Oct. 31, 2017, whose priority is claimed on Japanese Patent Application No. 2016-236473, filed Dec. 6, 2016. The entire contents of both the above PCT International Application and the above Japanese Application are incorporated herein by reference.

### FIELD OF THE INVENTION

### Description of Related Art

Conventionally, a system which connects an information processing terminal such as a personal computer or tablet of an individual user to a network via an access point such as a wireless LAN and provides a predetermined service is known. For example, a system which performs education using the information processing terminal of an individual student at a school or the like is known (Japanese Unexamined Patent Application, First Publication No. 2014-127033).

In such a system, in order to limit the number of terminals which can be connected to a network, a MAC address filtering function which does not allow terminals other than terminals having a specific MAC address to connect to the network is known.

### SUMMARY OF THE INVENTION

However, it is possible to know the specific MAC address from the outside by capturing a packet of a wireless LAN whose MAC address is not encrypted, and the like. In addition, the MAC address can be changed using a tool and the like. For this reason, if an attacker changes the MAC address of his own terminal to the specific MAC address, the attacker is connected to a network via an access point, and thus the conventional MAC address filtering function has a problem that security is not sufficient.

Therefore, in one aspect, the present invention aims to improve security of communication via an access point.

According to one proposal, an information processing apparatus includes an acquisition unit configured to acquire information indicating whether a user of a terminal performing communication via an access point is present, and a setting unit configured to set communication addresses of terminals permitted to perform communication via the access point on the basis of information acquired by the acquisition unit.

### BRIEF DESCRIPTION OF THE DRAWINGS

FIG. 1 is a diagram which shows a configuration example of an information processing system according to an embodiment.

FIG. 2 is a diagram which shows a hardware configuration example of an information processing apparatus according to the embodiment.

FIG. 3 is a diagram which shows an example of a hardware configuration of an access point according to the embodiment.

FIG. 4 is a diagram which shows an example of a functional block diagram of the information processing apparatus.

FIG. 5 is a sequence diagram which shows an example of a processing procedure executed in an information processing system.

FIG. 6A is a diagram which shows an example of a screen for inputting a student's attendance.

FIG. 6B is a diagram which shows another example of the screen for inputting a student's attendance.

FIG. 7 is a diagram which shows an example of student information.

### BRIEF DESCRIPTION OF THE INVENTION

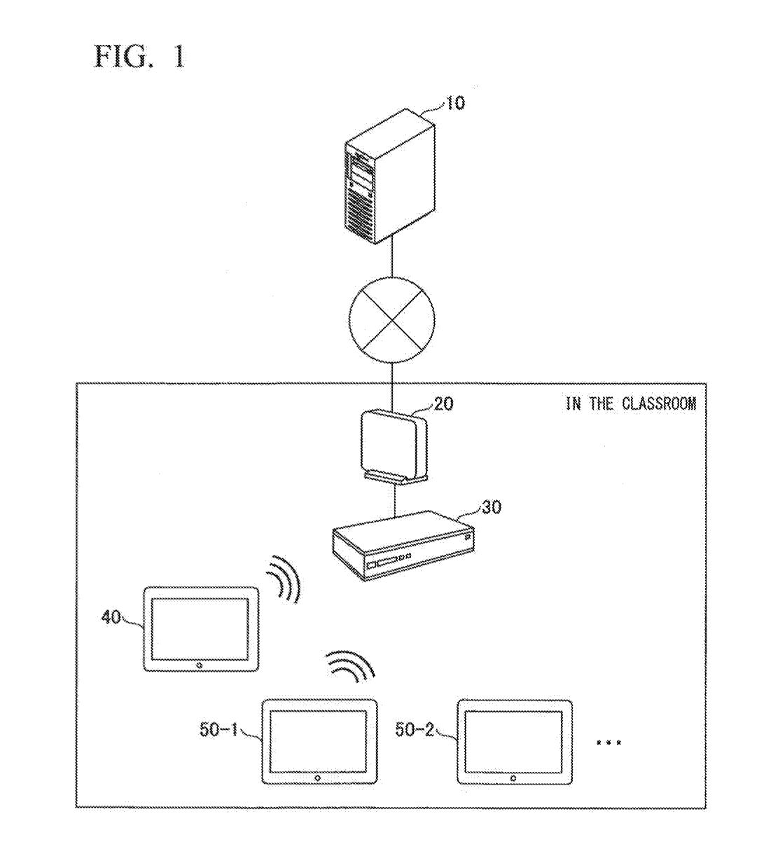

Hereinafter, embodiments of the present invention will be described with reference to the drawings. FIG. 1 is a diagram which shows a configuration example of an information processing system 1 according to an embodiment. Note that a case in which the information processing system 1 is applied to a school will be described as an example in the following description, but the information processing system 1 can be applied to a system in which, for example, a user who is present in a room such as a conference room, a lecture hall, or an office is connected to a network from a terminal thereof via the access point 20.

In FIG. 1, the information processing system 1 includes an information processing apparatus 10, an access point 20, a control device 30, a teacher's terminal 40, and students' terminals 50-1, 50-2, . . . (hereinafter, when these are not distinguished from each other, they are simply referred to as a “student's terminal 50”).

The information processing apparatus 10 and the access point 20 are communicably connected by a communication network such as a LAN or the Internet.

The control device 30 and the access point 20 are communicably connected by near field radio such as wireless local area network (LAN) or by a cable such as a LAN cable. In addition, the control device 30 is connected to a console port of the access point 20 by a serial cable conforming to, for example, RJ-45 or the like. Note that the console port is a communication port for setting the access point 20.

The information processing apparatus 10, the control device 30, the teacher's terminal 40, and the student's terminal 50 are communicably connected to each other via the access point 20.

The information processing apparatus 10 is a computer which distributes teaching material data to and collects answer data from the teacher's terminal 40 and the student's terminal 50. In addition, the information processing apparatus 10 stores data of an attendance list of students for each class.

Further, the information processing apparatus 10 sets the access point 20 via the control device 30 according to an input operation of the attendance list from the teacher's terminal 40.

The access point 20 is, for example, an access point of a wireless LAN. The access point 20 receives setting of a MAC address filtering function, a function related to the security, and the like via the console port.

The access point 20 gives an IP address to the teacher's terminal 40, the student's terminal 50, and the like using, for example, dynamic host configuration protocol (DHCP).

When a plurality of terminals having different IP addresses use the same MAC address, the access point 20 discards a packet addressed to the MAC address, and stores the fact in an internal storage device as an error log. In this case, the access point 20 may notify an external device such as the information processing apparatus 10 that there are the plurality of terminals using the same MAC address. Note that each function of the access point 20 described above may be realized by using a known technology.

The teacher's terminal 40 and the student's terminal 50 are, for example, terminals such as a personal computer (PC), a tablet terminal, or a smart phone.

The teacher's terminal 40 is a terminal used by a teacher and is used for inputting the attendance of each student in an attendance list provided by the information processing apparatus 10.

The student's terminal 50 is a terminal used by an individual student. Note that each student uses one student's terminal 50. For this reason, students and the students' terminals 50 are associated one to one.

The control device 30 is installed in, for example, a classroom, and controls apparatuses such as an electronic blackboard installed in the classroom. Moreover, the control device 30 sets the access point 20 via the console port according to an instruction from the information processing apparatus 10.

Hardware Configuration Example

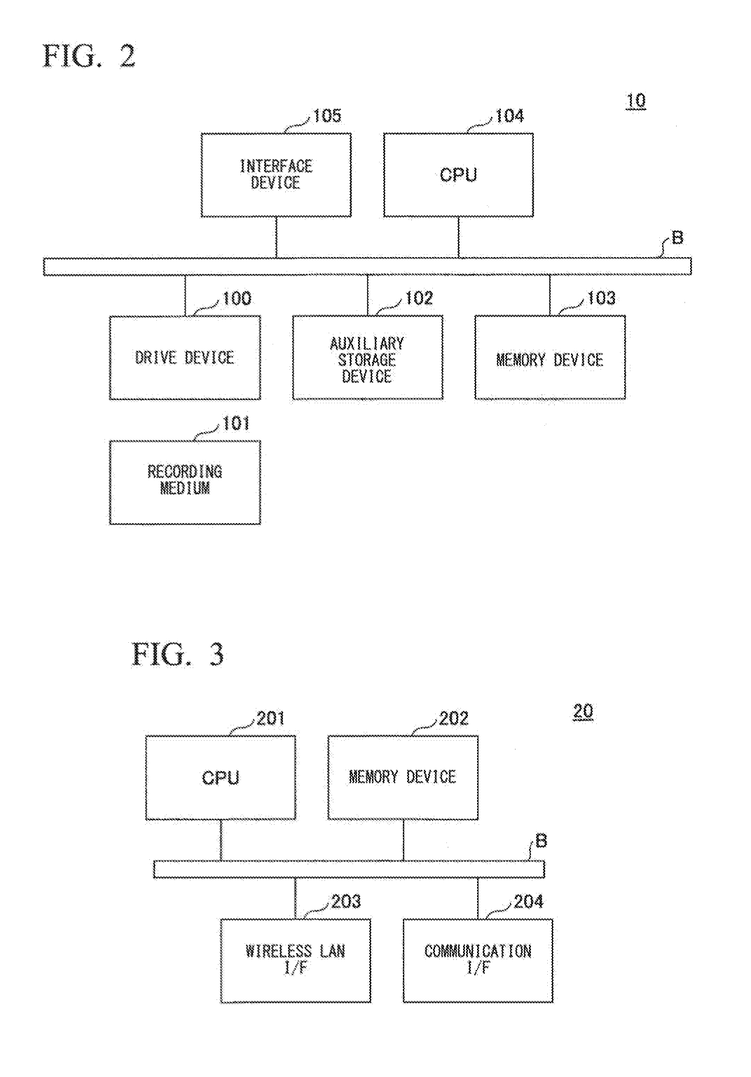

FIG. 2 is a diagram which shows a hardware configuration example of an information processing apparatus 10 according to the embodiment. The information processing apparatus 10 of FIG. 2 includes a drive device 100, an auxiliary storage device 102, a memory device 103, a CPU 104, an interface device 105, and the like which are connected to one another through a bus B.

An information processing program for realizing the processing in the information processing apparatus 10 is provided by a recording medium 101. When the recording medium 101 in which the information processing program is recorded is set in the drive device 100, the information processing program is installed in the auxiliary storage device 102 from the recording medium 101 via the drive device 100. However, the installation of the information processing program does not necessarily have to be performed by the recording medium 101, and may be downloaded from another computer via the network. The auxiliary storage device 102 stores the installed information processing program and stores necessary files, data, and the like. The memory device 103 reads and stores the program from the auxiliary storage device 102 when there is an instruction to start the program. The CPU 104 realizes a function of the information processing apparatus 10 according to the program stored in the memory device 103. The interface device 105 is used as an interface for connecting to the network.

Examples of the recording medium 101 include a portable recording medium such as a CD-ROM, a DVD disc, or a USB memory. In addition, examples of the auxiliary storage device 102 include a hard disk drive (HDD), a flash memory, or the like. Any one of the recording medium 101 and the auxiliary storage device 102 corresponds to a computer-readable recording medium.

Note that a hardware configuration of the control device 30, the teacher's terminal 40, and the student's terminal 50 may also be similar to the hardware configuration example of the information processing apparatus 10 shown in FIG. 2.

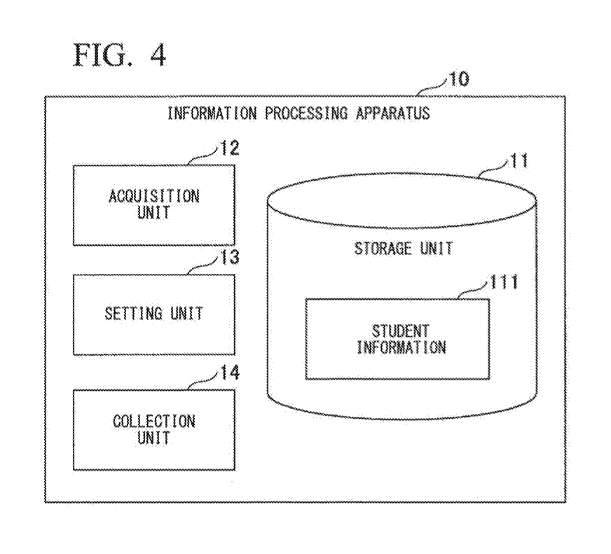

FIG. 3 is a diagram which shows an example of a hardware configuration of the access point 20 according to the embodiment.

The access point 20 includes a CPU 201, a memory device 202, a wireless LAN interface (I/F) 203, a communication I/F 204, and the like which are connected to one another through the bus B.

The CPU 201 realizes functions related to the access point 20 according to a program stored in the memory device 202.

The wireless LAN interface (I/F) 203 performs wireless LAN communication conforming to, for example, the IEEE 802.11 standard.

The communication I/F 204 performs communication conforming to, for example, Ethernet (registered trademark).

Functional Block

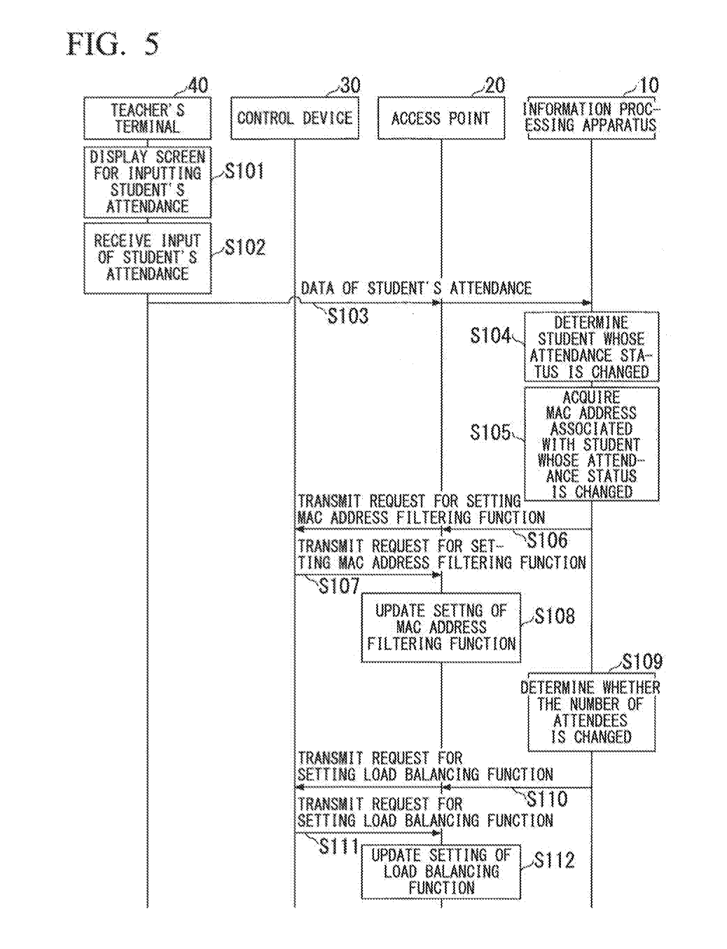

Next, a functional configuration of the information processing apparatus 10 will be described with reference to FIG. 4. FIG. 4 is a diagram which shows an example of a functional block diagram of the information processing apparatus 10. The information processing apparatus 10 includes an acquisition unit 12, a setting unit 13, and a collection unit 14. These units are realized by processing of causing the CPU 104 of the information processing apparatus 10 to execute one or more programs installed in the information processing apparatus 10.

In addition, the information processing apparatus 10 includes a storage unit 11. The storage unit is realized using, for example, the auxiliary storage device 102 and the like. The storage unit 11 stores student information 111 and the like. Note that the student information 111 will be described below.

The acquisition unit 12 acquires information indicating whether each student is present.

The setting unit 13 sets the MAC address filtering function of the access point 20 on the basis of information acquired by the acquisition unit 12. More specifically, the setting unit 13 deletes the MAC address of a student's terminal 50 associated with an absent student from a list of the MAC addresses permitted to perform communication at the access point 20, and adds the MAC address of a student's terminal 50 associated with a user who is present to the list.

In addition, the setting unit 13 sets a load balancing function of the access point 20 on the basis of information acquired by the acquisition unit 12.

When a student's terminal 50 is connected to the access point 20 via a LAN cable and the like, for example, before the students' terminals 50 are distributed to respective students, the collection unit 14 collects the host name and MAC address of the student's terminal 50 via a network and adds the collected host name and MAC address to the student information 111. That is, the student information 111 is information including a list of host names, MAC addresses, and the like of the students' terminals 50 associated with respective students. Furthermore, the student information 111 is information including, for example, student names and the like of respective students, which are input while a teacher refers to the host names of the student information 111.

The collection unit 14 may collect the host name and MAC address of a student's terminal 50, for example, using a function provided by an OS of the information processing apparatus 10. In this case, for example, a “net view” command and an “nbtstat” command which are provided by a Windows (registered trademark) OS may also be used. Alternatively, the collection unit 14 may be notified of the host name and MAC address of a student's terminal 50 acquired by the student's terminal 50.

Processing

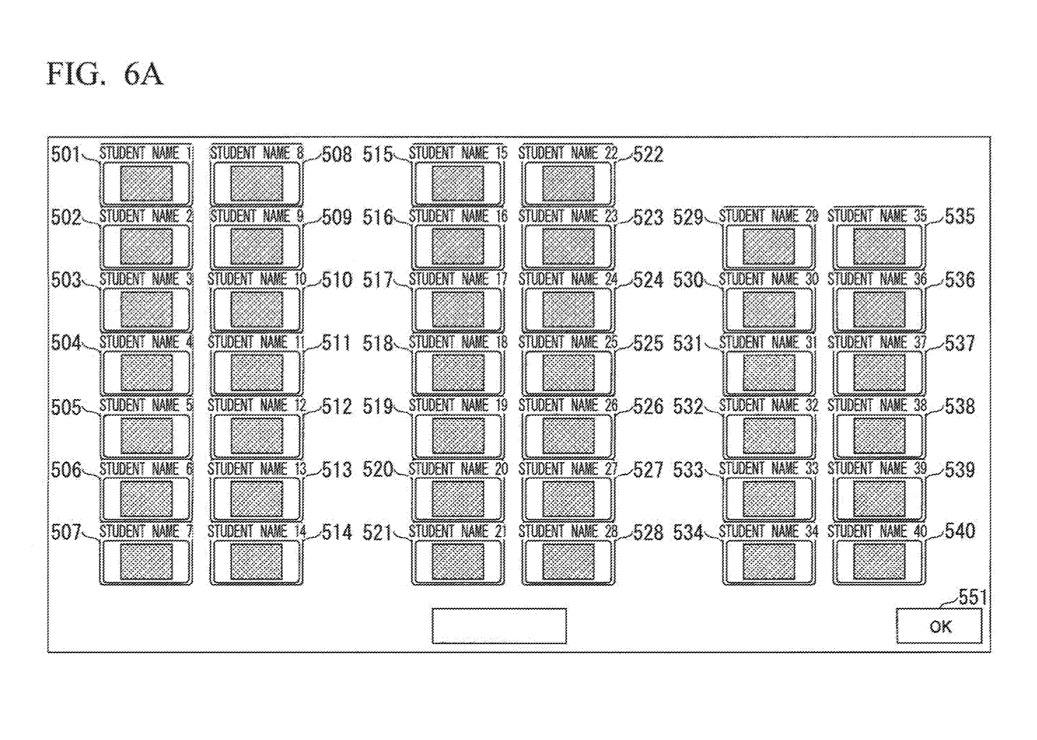

Next, a processing procedure executed in the information processing system 1 will be described with reference to FIG. 5. FIG. 5 is a sequence diagram which shows an example of a processing procedure executed in the information processing system 1.

In step S101, the teacher's terminal 40 displays, for example, a screen (an input screen of an attendance list) for a teacher to input a student's attendance according to a predetermined operation.

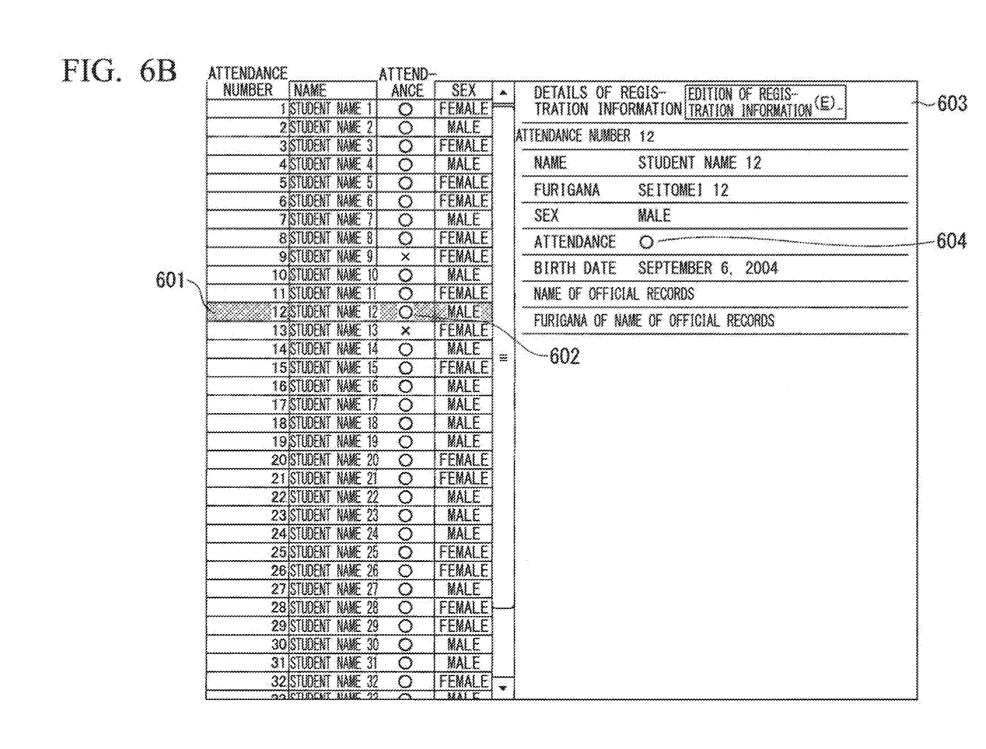

FIG. 6A is a diagram which shows an example of a screen for inputting a student's attendance. In the example of FIG. 6A, icons 501 to 540 of desks of each student are displayed. In each of the icons 501 to 540, for example, a green mark indicating “attendance” is added as default. A teacher selects an icon corresponding to a student who is absent, thereby setting a red mark indicating “absent” for the icon. If an “OK” button 551 is pressed, data of attendance based on the green or red mark set for each icon is transmitted to the information processing apparatus 10.

FIG. 6B is a diagram which shows another example of the screen for inputting a student's attendance. In the example of FIG. 6B, attendance is displayed in association with a name of each student. For example, a teacher selects an attendance column 602 associated with a student name 601 to be input, thereby setting a mark of “x” indicating “absent” and, for example, a mark of “O” indicating “present.” In addition, the teacher also selects an attendance column 604 on a screen 603 displaying detailed information of a student for whom input is to be performed, which is displayed by selecting the student name 601 to be input, thereby setting the mark of “x” indicating “absent” and, for example, the mark of “O” indicating “present.”

The teacher's terminal 40 receives an input of student's attendance from a teacher according to the operation described above (step S102).

Subsequently, the teacher's terminal 40 transmits data of the student's attendance to the information processing apparatus 10 (step S103). The data of the student's attendance includes each student's ID and information indicating whether each student is present or absent. The data is received by the acquisition unit 12 of the information processing apparatus 10.

Then, the setting unit 13 of the information processing apparatus 10 determines a student whose current attendance status is changed from the previous attendance status on the basis of data of the student's attendance received by the acquisition unit 12 and the student information 111 (step S104). That is, the student information 111 at the start of step S104 includes information based on data of attendance at the time of inputting the previous attendance.

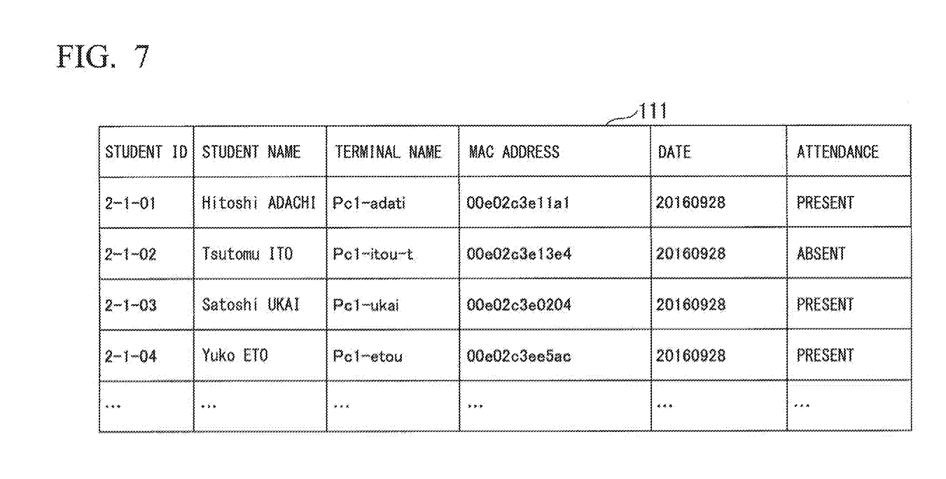

FIG. 7 is a diagram which shows an example of student information 111. As the student information 111, items of a student name, a terminal name, a MAC address, date, and attendance are stored in association with a student ID.

A student ID is an ID for identifying a student. A student name is a name of a student. A terminal name is a host name in a DNS and the like of a student's terminal 50 used by a student. A MAC address is the MAC address of a student's terminal 50 used by a student. A date is a date on which the data of attendance has been input. Attendance is information indicating an attendance status of whether a student is present or absent.

In step S104, it is determined that a student whose attendance associated with the student ID received in step S103 does not match a corresponding student ID stored in the student information 111 is a student whose attendance has changed.

Note that a student ID, a student name, a terminal name, and a MAC address may be registered in advance. In addition, a date and attendance are updated on the basis of data of a current date and received data of a student's attendance after the processing of step S104 is executed.

Subsequently, the setting unit 13 of the information processing apparatus 10 acquires a MAC address of the student's terminal 50 associated with a student whose attendance is changed from the student information 111 (step S105).

Then, the setting unit 13 of the information processing apparatus 10 transmits a request for setting a MAC address filtering function to the control device 30 on the basis of the acquired MAC address (step S106).

Then, the control device 30 transmits the request for setting a MAC address filtering function to the access point 20 on the basis of the received MAC address using the console port (step S107). Here, the control device 30 registers a MAC address associated with a student whose attendance has changed from absence to presence in a list of MAC addresses to be subjected to MAC address filtering, and transmits a command for deleting a MAC address associated with a student whose attendance has changed from presence to absence from the list of MAC addresses to be subjected to MAC address filtering. The access point 20 permits a connection (communication) of students' terminals 50 related to the MAC addresses included in the list, and does not permit the connection (communication) of students' terminals 50 which are related to the MAC addresses not included in the list. As a result, the connection of a student's terminal 50 of a student who is absent is not permitted.

Subsequently, the access point 20 updates setting of a MAC address filtering function according to the request (step S108).

Then, the setting unit 13 of the information processing apparatus 10 determines whether the number of attendees at this time is the same as the number of attendees from the last time (step S109).

Then, the setting unit 13 of the information processing apparatus 10 transmits a request for setting a load balancing function to the control device 30 on the basis of the number of attendees at this time when the number of attendees at this time is not the same as the number of attendees from the last time (step S110). For example, the number of attendees at this time is set as the maximum number of connected units (maximum number) of a load balancing function.

Subsequently, the control device 30 transmits the request for setting a load balancing function to the access point 20 using the console port (step S111).

Then, the access point 20 updates setting of a load balancing function according to the request (step S112).

### Modified Example

The setting of the MAC address filtering function and the load balancing function with respect to the access point 20 may be set using HTTP and the like instead of using the console port. In this case, the setting unit 13 of the information processing apparatus 10 may set the access point 20 not via the control device 30.

The setting unit 13 of the information processing apparatus 10 may perform setting of the MAC address filtering function and setting of the load balancing function described above for each network by the access point 20. In this case, the acquisition unit 12 of the information processing apparatus 10 acquires, for example, a student ID, a service set identifier (SSID) that is information for identifying a network of a connection destination, and data of the attendance of a student including the attendance indicating presence or absence from the teacher's terminal 40. Then, the setting unit 13 of the information processing apparatus 10 performs the setting of the MAC address filtering function and the setting of the load balancing function on each corresponding SSID. In this case, for example, one SSID (hereinafter, referred to as “SSID1”) in the access point 20 is a setting that can be connected to a LAN and a WAN in a school, and another SSID (hereinafter, referred to as “SSID2”) is set to a setting that can be connected only to the WAN. Then, for example, in the teacher's terminal 40, for example, a classroom chairperson and predetermined related students are designated to connect to the SSID1, and other students are designated to connect to the SSID2. As a result, for example, the classroom chairperson and predetermined related students can receive distribution of teaching material data from the information processing apparatus 10 via the Internet and acquire predetermined data from a file server connected to the LAN in the school.

### SUMMARY

According to the embodiments described above, the MAC address filtering function of the access point 20 is set such that only the MAC addresses used by students who are present can access a network. That is, the MAC address corresponding to an absent student is restricted (prohibited) to access the network. In this manner, for example, without consciousness of a teacher and the like, and without assistance of ICT support staff and the like, it is possible to prevent an attacker from illegally accessing the network by using a terminal rewritten as the MAC address of an absent person, a withdrawal person, or the like. As a result, security of communication via the access point can be improved.

In addition, when an attacker uses a terminal rewritten as the MAC address of an attendee, since a plurality of terminals having different IP addresses use the same MAC address, the terminal of the attendee and the terminal of the attacker cannot communicate via the access point 20. For this reason, even in this case, it is possible to prevent the attacker from accessing the network.

As described above, although the embodiments of the present invention have been described in detail, the present invention is not limited to such specific embodiments, and various modifications or changes can be made within the scope of the gist of the present invention described in the claims.

Each functional unit of the information processing apparatus 10 may be realized by, for example, cloud computing constituted by one or more computers. The information processing apparatus 10 may be integrated with the access point 20. In addition, the information processing apparatus 10 may be integrated with the control device 30.

What is claimed is:

1. An information processing apparatus comprising:
an acquisition unit configured to acquire information indicating whether a user of a terminal performing communication via an access point is present; and
a setting unit configured to set communication addresses of terminals permitted to perform communication via the access point on the basis of information acquired by the acquisition unit.

2. The information processing apparatus according to claim 1,
wherein the acquisition unit acquires information identifying a user who is present and information identifying a user who is absent, and
the setting unit deletes a communication address associated with an absent user, which is acquired by the acquisition unit, from communication addresses permitted to perform communication via the access point, and adds a communication address associated with a present user, which is acquired by the acquisition unit, to the communication addresses permitted to perform communication via the access point.

3. The information processing apparatus according to claim 1,
wherein the setting unit sets the maximum number of terminals permitted to perform communication via the access point on the basis of information acquired by the acquisition unit.

4. The information processing apparatus according to claim 1, further comprising:
a collection unit configured to collect communication addresses of terminals; and
a storage unit configured to store input identification information of a user and a communication address of the terminal collected by the collection unit in association with each other,
wherein the setting unit acquires the communication addresses of terminals permitted to perform communication via the access point from the storage unit on the basis of information identifying a user included in information acquired by the acquisition unit.

5. The information processing apparatus according to claim 1,
wherein the acquisition unit acquires information identifying a network of a connection destination according to a present user, and
the setting unit sets communication addresses permitted to perform communication with the network of the connection destination via an access point according to the information identifying the network of the connection destination.

6. Anon-transitory computer-readable recording medium storing a program which causes a computer to execute
processing of acquiring information indicating whether a user is present; and
processing of setting communication addresses permitted to perform communication via an access point on the basis of information acquired by the processing of acquiring information.

7. A non-transitory computer-readable recording medium storing the program according to claim 6,
wherein the processing of acquiring information includes acquiring information identifying a user who is present and information identifying a user who is absent, and
the processing of setting communication addresses includes deleting a communication address associated with a user who is absent, which is acquired in the processing of acquiring information, from the communication addresses permitted to perform communication via the access point, and adding a communication address associated with a user who is present, which is acquired in the processing of acquiring information, to the communication addresses permitted to perform communication via the access point.

8. A non-transitory computer-readable recording medium storing the program according to claim 6,
wherein the processing of setting communication addresses includes setting the maximum number of terminals permitted to perform communication via the access point on the basis of information acquired in the processing of acquiring information.

9. A non-transitory computer-readable recording medium storing the program according to claim 6, further causing a computer to execute
processing of collecting a communication address of a terminal; and
processing of storing input identification information of a user and the communication address of the terminal collected in the processing of collecting a communication address in association with each other,
wherein the processing of setting communication addresses includes acquiring the communication addresses of terminals permitted to perform communication via the access point from information stored in the processing of storing input identification information of a user and the communication address of a terminal on the basis of information identifying a user, which is included in the information acquired in the processing of acquiring information.

10. A non-transitory computer-readable recording medium storing the program according to claim 6,
wherein the processing of acquiring information includes acquiring information identifying a network of a connection destination according to a user who is present, and
the processing of setting communication addresses includes setting communication addresses permitted to perform communication with the network of the connection destination via an access point according to information identifying the network of the connection destination.

11. The information processing apparatus according to claim 2, further comprising:
a collection unit configured to collect communication addresses of terminals; and
a storage unit configured to store input identification information of a user and a communication address of the terminal collected by the collection unit in association with each other,
wherein the setting unit acquires the communication addresses of terminals permitted to perform communication via the access point from the storage unit on the basis of information identifying a user included in information acquired by the acquisition unit.

12. The information processing apparatus according to claim 3, further comprising:
a collection unit configured to collect communication addresses of terminals; and
a storage unit configured to store input identification information of a user and a communication address of the terminal collected by the collection unit in association with each other,
wherein the setting unit acquires the communication addresses of terminals permitted to perform communication via the access point from the storage unit on the basis of information identifying a user included in information acquired by the acquisition unit.
